(19) United States
(12) Patent Application Publication
(10) Pub. No.: US 2008/0238036 A1
(43) Pub. Date: Oct. 2, 2008

(54) Safety chain anchors

(76) Inventors: Betty M. Baum, Tustin, MI (US); James L. Baum, Tustin, MI (US)

Correspondence Address: JAMES RAY & ASSOCIATES, 2640 PITCAIRN ROAD, MONROEVILLE, PA, 15146, US

(21) Appl. No.: 12/075,964

(22) Filed: Mar. 14, 2008

Related U.S. Application Data
(60) Provisional application No. 60/908,424, filed on Mar. 28, 2007.

(51) Int. Cl. B60D 1/36

(52) U.S. Cl. 280/477

(57) ABSTRACT

An apparatus engageable with a framework or supporting member of a tow vehicle for securing drop down safety chains from a gooseneck trailer. The apparatus comprises a bracket member having a predetermined shape and formed of a predetermined material, such shape includes a bend formed therein. The bend being bent at an angle. An aperture is disposed on a bottom portion of the bracket. A generally U-shaped member is disposed as a loop on the bracket, the U-shaped member is disposed on an upper portion of the bracket for engagement with such safety chains from such gooseneck trailer. A rod member is engageable with the aperture in the bracket and is further engageable with an aperture in one of the framework or supporting member on such tow vehicle. A cotter pin secures the rod member in place.

### CROSS REFERENCE TO RELATED APPLICATIONS

This application is closely related to and claims benefit from U.S. Provisional Application Ser. No. 60/908,424 filed Mar. 28, 2007.

### FIELD OF THE INVENTION

The present invention relates, in general, to a safety chains, and, more particularly, the present invention relates to specialized hooks for securing drop down safety chains from horse or other trailers connected to a tow vehicle.

### BACKGROUND OF THE INVENTION

When a gooseneck or a horse trailer is not properly affixed or not completely secured to the tow vehicle (truck), driving over bumpy roads or treacherous terrain, making turns or other hazards encountered on the road can cause the truck and trailer to become separated which creates a dangerous situation.

Thus, it would be advantageous if there were an apparatus or a means by which the trailer could be firmly secured to the tow vehicle so as to provide an additional level of safety when towing such gooseneck or horse trailers.

### SUMMARY OF THE INVENTION

In a first aspect the present invention provides an apparatus that is engageable with one of a framework and a supporting member disposed on a tow vehicle for securing drop down safety chains from one of horse trailers and gooseneck trailers. The apparatus comprises at least one bracket member having a predetermined shape and a predetermined size and formed of a predetermined material. The predetermined shape includes a bend formed in the bracket member, the bend being bent at a predetermined angle. There is an aperture disposed on a bottom portion of the bracket member. A generally U shaped member is disposed as a loop on the bracket member, the U-shaped member is disposed on an upper portion of the bracket member for engagement with such drop down safety chain from either one of such horse trailer or such gooseneck trailer. A rod member is engageable with the aperture disposed in the bracket member and is further engageable with an aperture disposed in such one of a framework or supporting member on such tow vehicle for securing the apparatus to such tow vehicle. There is also a means for securing the rod member in place and preventing the rod member from sliding out.

### OBJECTS OF THE INVENTION

It is, therefore, one of the primary objects of the present invention to provide a safety chain anchor for securing a trailer that is being towed.

Another object of the present invention to provide a safety chain anchor that is engageable with the framework or supporting structure on the tow vehicle.

Still another object of the present invention to provide a safety chain anchor for use with a horse trailer or a gooseneck trailer.

Yet another object of the present invention to provide a safety chain anchor that is held in place by means of a rod member which passes through an aperture in the tow vehicle framework and the anchor.

Another object of the present invention is to provide a safety chain anchor in which the rod has a bend on one end and a cotter pin on the opposite end.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a perspective view of the bracket and rod members according to an embodiment of the invention.

FIG. 2 is a perspective view of the bracket member according to an alternate embodiment of the invention.

FIG. 3 is a perspective view of the apparatus in place on the back of a tow vehicle.

FIG. 4 is a perspective view of the apparatus on the back of a tow vehicle showing the safety chains from the towed trailer connected to the apparatus.

FIG. 5 is perspective view of the rod member according to an alternate embodiment of the invention.

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, that is engageable with one of a framework and a supporting member disposed on a tow vehicle for securing drop down safety chains from one of horse trailers and gooseneck trailers. The apparatus 10 comprises at least one bracket member 2 having a predetermined shape and a predetermined size and formed of a predetermined material. The predetermined shape includes a bend formed in the bracket member 2, the bend being bent at a predetermined angle. There is an aperture 4 disposed on a bottom portion of the bracket member 2. A generally U shaped member 6 is disposed as a loop on the bracket member 2, the U-shaped member 6 is disposed on an upper portion of the bracket member 2 for engagement with such drop down safety chain 22 from either one of such horse trailer or such gooseneck trailer. A rod member 8 is engageable with the aperture 4 disposed in the bracket member and is further engageable with an aperture disposed in such one of a framework or supporting member on such tow vehicle for securing the apparatus 10 to such tow vehicle. There is also a means, generally designated 20, for securing the rod member 8 in place and preventing the rod member 8 from sliding out.

It is presently preferred that such rod member have at least one aperture 12 disposed on an end thereof as part of the means 20 for securing such rod member 8 to the framework of the tow vehicle. It is within the concept of the invention that such rod member has an aperture 12 disposed on each end thereof.

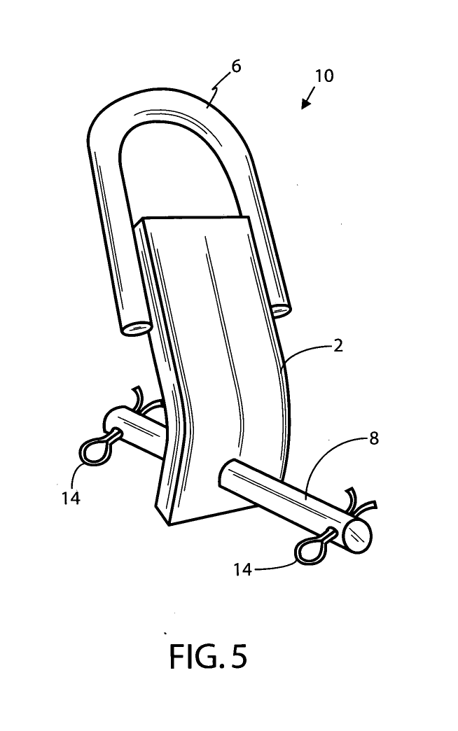

Such securing means 20 for securing the rod member 8 further includes at least one cotter pin 14 that is engageable with the aperture 12 disposed on the end of rod member 8. In one embodiment wherein the rod member 8 has aperture 12 disposed on each end of the rod member 8 such means for securing the rod member 8 includes a cotter pin 14 engageable with each aperture 12 disposed on the rod member 8 as seen in FIG. 5.

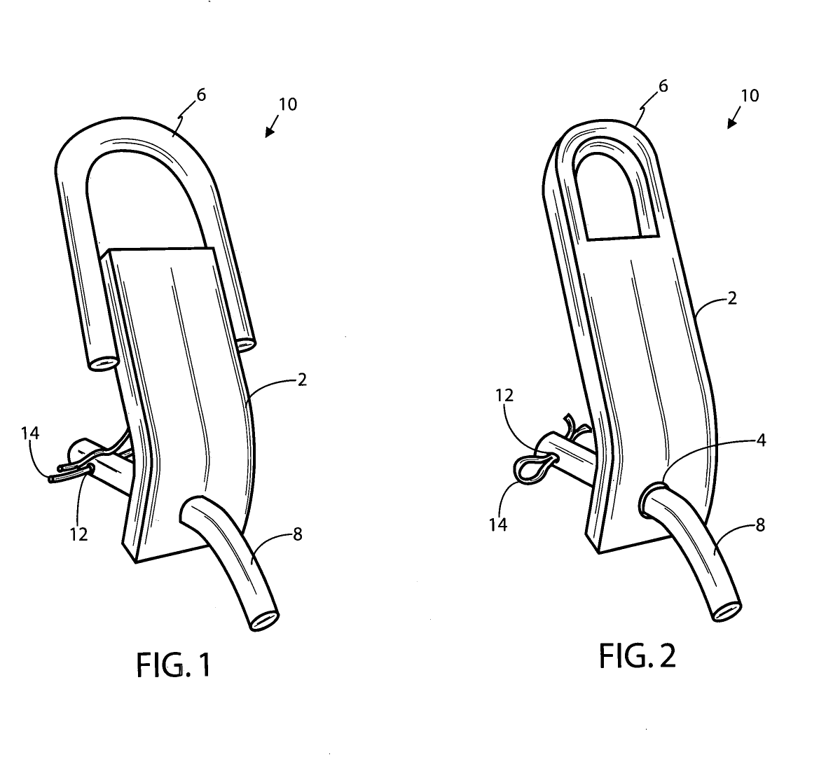

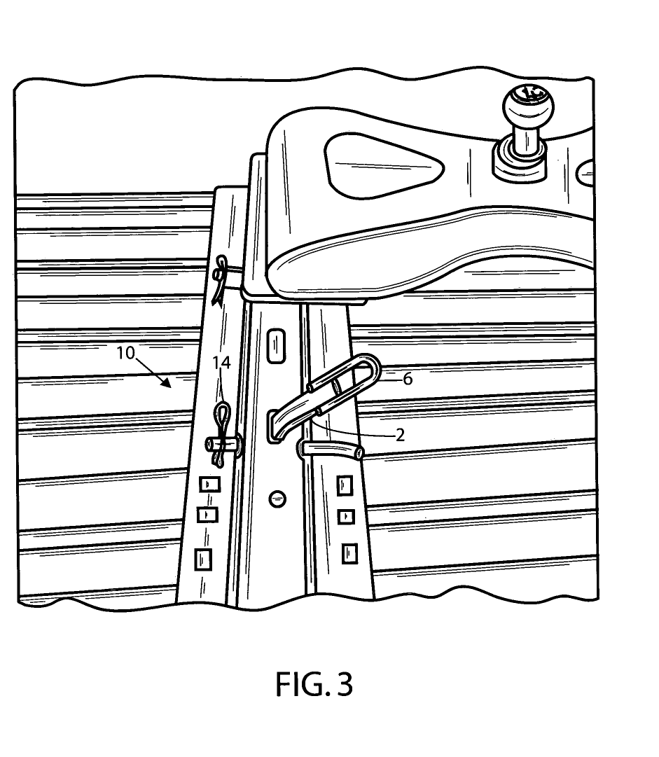

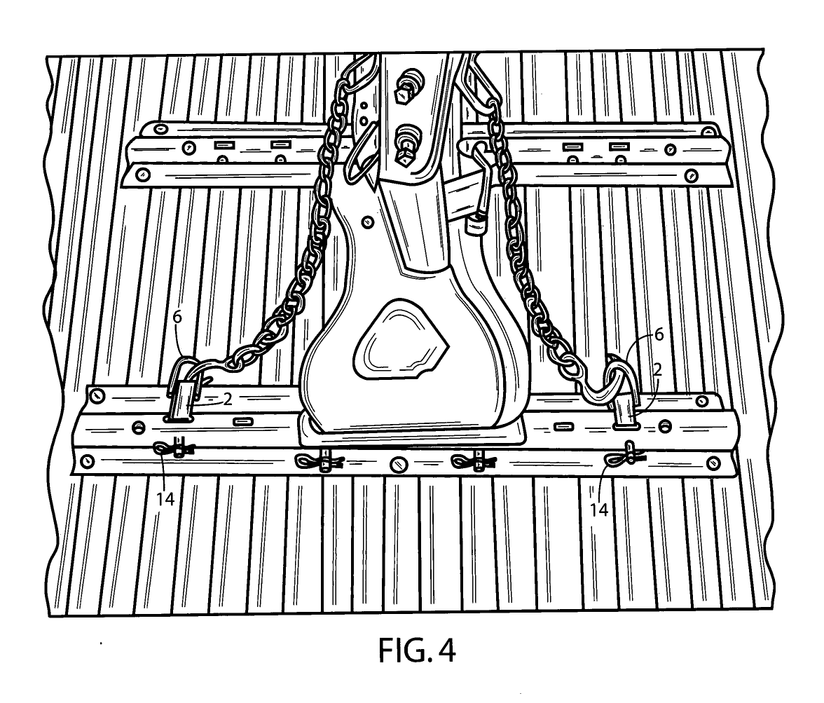

However, in a preferred embodiment of the invention, as seen in FIGS. 1, 2 such rod member 8 has a predetermined bend disposed therein closely adjacent one end thereof. The bend in rod member 8 prevents the rod member 8 from sipping out when there is a cotter pin 14 disposed in the aperture 12 that is formed on the end of the rod member 8 opposite the bend. Thus, the aperture 12 in the rod member is disposed on an end of the rod member 8 opposite the end closely adjacent the bend, wherein such predetermined bend assists in retaining the rod member 8 in place. In the embodiment wherein the rod member 8 has a bend formed therein there is only one aperture 12 in the rod member 8.

The U-shaped member 6 can either be formed as part of the bracket member, as seen in FIG. 2, or as and as a separate unit attached to the bracket member 2, as seen in FIG. 1. It is presently preferred that such U-shaped loop member 6 be formed as a separate unit and attached to the bracket member 2 and also preferred that such U-shaped member 6 be attached to the bracket 2 by welding.

The predetermined angle in bracket member is between about 40 and about 50 degrees and even more preferred that such angle is between about 43 and about 47 degrees.

It is within the concept of the invention that such apparatus includes two bracket members 2. The two bracket members 2 would be attached to the tow vehicle on opposite sides of the place where the gooseneck or mast of the towed vehicle is secured to the tow vehicle as seen in FIG. 4.

It should be noted that the predetermined shape of the bracket member 2 is generally rectangular with a bend formed therein close to one end of the bracket. Further, the aperture 4 disposed on the bottom portion of the bracket 2 is on an end opposite the end having U-shaped member 6 disposed thereon.

Thus, the present invention provides an anchor that is easy to attach the hooks from safety chains onto so as to hold the chains of the towed vehicle on the tow vehicle to further support the connection. The safety chain anchors (apparatus) are made of a ⅜ inch by 1¼ inch flat stock steel bent to a 45 degree angle with a hole drilled in the bottom allowing for the addition of a rod that will secure the anchor to the back deck of the tow vehicle. The anchors slide into the vehicles framework for a secure hold. The user can then connect the safety chains to the anchor to further ensure that the towed vehicle is securely attached.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

We claim:

1. An apparatus engageable with one of a framework and a supporting member disposed on a tow vehicle for securing drop down safety chains from one of horse trailers and gooseneck trailers, said apparatus comprising:
(a) at least one bracket member having a predetermined shape and a predetermined size and formed of a predetermined material;
(b) an aperture disposed on a bottom portion of said bracket member;
(c) a generally U shaped member formed as a loop on said bracket member, said U-shaped member disposed on an upper portion of said bracket member for engagement with such drop down safety chain from such one of such horse trailer and such gooseneck trailer;
(d) a rod member engageable with said aperture disposed in said bracket member and further engageable with an aperture disposed in such one of a framework and supporting member on such tow vehicle for securing said apparatus to such tow vehicle; and
(e) a means for securing said rod member in place and preventing said rod member from sliding out.

2. The apparatus, according to claim 1, wherein said predetermined shape of said bracket member is generally rectangular.

3. The apparatus, according to claim 2, wherein said predetermined shape further includes a bend in said bracket member, said bend being bent at a predetermined angle;

4. The apparatus, according to claim 1, wherein said rod member has at least one aperture disposed on an end thereof.

5. The apparatus, according to claim 4, wherein said rod member has an aperture disposed on each end thereof.

6. The apparatus, according to claim 4, wherein said means for securing said rod member includes at least one cotter pin engageable with said aperture disposed on said end of said rod member.

7. The apparatus, according to claim 5, wherein said means for securing said rod member includes a cotter pin engageable with each aperture disposed on said rod member.

8. The apparatus, according to claim 6, wherein said rod member has a predetermined bend disposed therein closely adjacent one end thereof.

9. The apparatus, according to claim 8, wherein said aperture in said rod member is disposed on an end of said rod member opposite said end closely adjacent said bend, wherein said predetermined bend assists in retaining said rod member in place.

10. The apparatus, according to claim 1, wherein said U-shaped member is one of formed as part of said bracket member and as a separate unit attached to said bracket member.

11. The apparatus, according to claim 10, wherein said U-shaped member is a separate unit.

12. The apparatus, according to claim 11, wherein said U-shaped member is attached to said bracket member by means of welding.

13. The apparatus, according to claim 3, wherein said predetermined angle in said bracket member is between about 40 and about 50 degrees.

14. The apparatus, according to claim 13, wherein said predetermined angle is between about 43 and about 47 degrees.

15. The apparatus, according to claim 1, wherein said apparatus includes two bracket members.

16. The apparatus, according to claim 3, wherein said aperture disposed on said bottom portion of said bracket is on an end opposite an end having said U-shaped member disposed thereon.
